(19) United States
(12) Patent Application Publication
(10) Pub. No.: US 2026/0203030 A1
(43) Pub. Date: Jul. 16, 2026

(54) ENHANCING DOMAIN-SPECIFIC LANGUAGE-RELATED MEMORY SECURITY

(71) Applicant: International Business Machines Corporation, Armonk, NY (US)

(72) Inventors: Tong Chen, Yorktown Heights, NY (US); Alper Buyuktosunoglu, Yorktown Heights, NY (US)

(21) Appl. No.: 19/018,476

(22) Filed: Jan. 13, 2025

(51) Int. Cl. G06F 8/41

(52) U.S. Cl. CPC G06F 8/41

(57) ABSTRACT

A computer-implemented method includes processing, at a compile time of at least one domain-specific language program, at least a first set of data related to one or more memory access operations associated with the at least one domain-specific language program; processing, at a runtime of the at least one domain-specific language program and based at least in part on an output of the processing at the compile time, at least a second set of data related to one or more memory access operations associated with the at least one domain-specific language program; and performing, based at least in part on one or more outputs of the processing the at least a second set of data at the runtime, one or more automated actions related to enhancing memory security of the at least one domain-specific language program.

### BACKGROUND

The present application generally relates to information technology, and to memory security. For example, unsafe and/or unwanted memory access operations (e.g., storing or retrieving data in a computer's memory) are often vulnerabilities in programs which can be exploited by bad actors. More particularly, memory security issues involving domain-specific languages (DSLs) present challenges not addressed by conventional memory management techniques.

### SUMMARY

In at least one embodiment, an example computer-implemented method includes processing, at a compile time of at least one domain-specific language program, at least a first set of data related to one or more memory access operations associated with the at least one domain-specific language program. The method also includes processing, at a runtime of the at least one domain-specific language program and based at least in part on an output of the processing at the compile time, at least a second set of data related to one or more memory access operations associated with the at least one domain-specific language program. Further, the method additionally includes performing, based at least in part on one or more outputs of the processing the at least a second set of data at the runtime, one or more automated actions related to enhancing memory security of the at least one domain-specific language program, wherein performing the one or more automated actions includes modifying, according to at least one preset procedure, one or more configurations of the at least one domain-specific language program in response to at least a portion of the one or more outputs of the processing the at least a second set of data at the runtime.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a workflow and elements used therein, according to an example embodiment of the invention;

FIG. 2 shows example pseudocode for an in-bound example in connection with a static analysis in an illustrative embodiment;

FIG. 3 shows example pseudocode for a potentially not in-bound example in connection with a static analysis in an illustrative embodiment;

FIG. 4 shows example pseudocode for implementing at least a portion of a runtime analysis in an illustrative embodiment;

FIG. 5 is a flow diagram illustrating techniques according to an example embodiment of the invention; and

FIG. 6 is a diagram illustrating a computing environment in which at least one embodiment of the invention can be implemented.

### DETAILED DESCRIPTION

As described herein, at least one embodiment includes enhancing memory security for artificial intelligence-focused DSLs. Such an embodiment includes performing at least one static analysis of one or more memory elements to detect potential memory vulnerability at compile time, and implementing a dynamic and/or runtime check with special hardware instruction support for compilation of at least one DSL program. As used herein, static analysis refers to analysis performed at compile time, and dynamic analysis refers to analysis, at least in part, performed during runtime. The data being analyzed in such analyses can include, for example, the property of memory objects and the access patterns (e.g., index and enclosing loops).

Accordingly, and as further detailed herein, such static analysis can include using one or more loop analysis techniques and one or more data-flow analysis techniques to determine and/or identify unsafe and/or anomalous memory access. As used herein, loop analysis refers to analysis of the value range of the loop indices in at least one loop nest, while data-flow analysis refers to analysis of the relationship of the definition and the use of variables in a program. Also, in one or more embodiments, if at least one instance of memory access cannot be determined to be safe, one or more runtime analyses are carried out. In connection with a memory reference, a compiler will obtain the corresponding address and its valid range, as well as the corresponding lower bound and upper bound. If the compiler can prove the address is within in the valid range or out of the valid range, this memory reference is handled statically. Also, because there might be some value that is unknown to the compiler, instructions to check the bound can be inserted into the code and executed at runtime (i.e., dynamically).

Accordingly, at least one embodiment of the present invention may provide a beneficial effect such as, for example, enhancing memory security for artificial intelligence-focused DSL implementations.

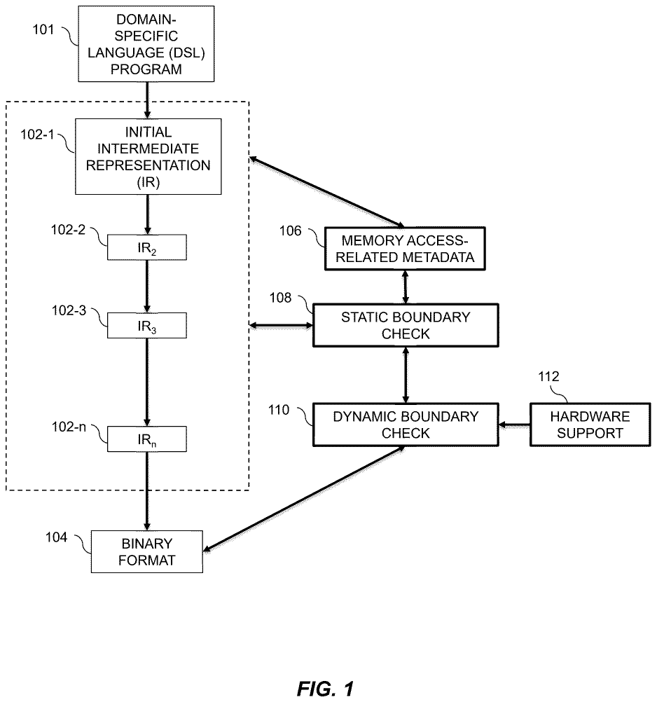

FIG. 1 is a diagram illustrating a workflow and elements used therein, according to an example embodiment of the invention. As used herein, DSLs are focused at least in part on functionality in one or more specialized domains (e.g., as used in machine learning frameworks). By way of illustration, FIG. 1 depicts a DSL program 101, which can be represented using at least one initial compiler intermediate representation (IR) 102-1, followed by additional IRs 102-2, 102-3, . . . 102-n, collectively referred to herein as IRs 102. Additionally, as depicted in FIG. 1, through the sequence of IRs 102, the DSL program 101 is converted and/or rewritten to at least one binary format 104. Such a binary format 104 can include, for example, one or more function calls to one or more libraries written in other languages. During IR conversion sequences, however, memory security vulnerabilities can be introduced.

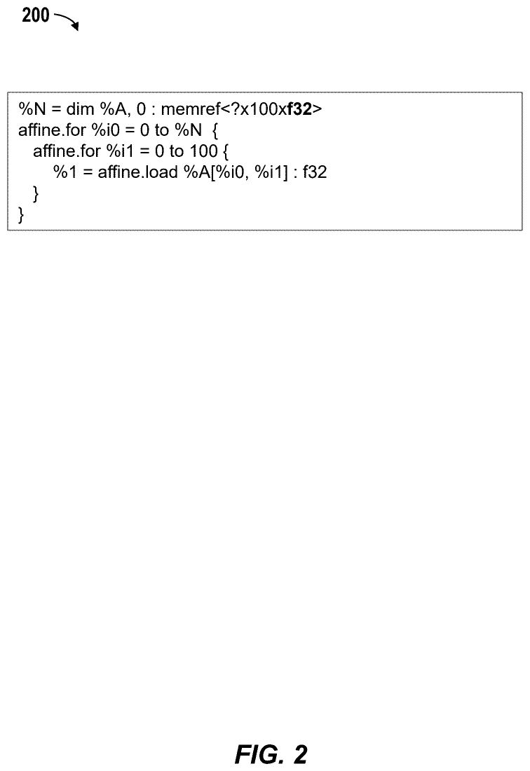

That said, as depicted in FIG. 1, the IR conversion sequence of the DSL program 101 can generate memory access-related metadata 106 that can be leveraged for enhancing memory safety. By way merely of example, in FIG. 2, in connection with the memory load “affine.load % A [% i0, % i1],” the memory object % A is associated with its metadata “memref<?x100xf32>”. Also, for example, DSL specifications can contain high-level semantics for one or more memory objects, including, e.g., bound information, ownership information, etc. As such, referring again to FIG. 1, based at least in part on the memory access-related metadata 106 and the IR conversion process, at least one static boundary check can be performed in step 108 (e.g., comparing the address with its bound at compile time).

Based at least in part on the output of the static boundary check (e.g., a compile-time boundary check) in step 108, in conjunction with hardware support 112 (e.g., supporting the bound comparison directly with hardware), a dynamic boundary check (e.g., a runtime boundary check) is generated and/or performed in step 110. In one or more embodiments, a difference between a static boundary check and a dynamic boundary check is whether comparison can be performed at compile time. If all of the values are known at compile time, the comparison can be performed at compile time. If at least one value is unknown, a symbolic analysis can be performed. For example, n+1 is always less than n+3. Further, as depicted in FIG. 1, based at least in part on the output of the dynamic boundary check in step 110 as well as the IR conversion sequence, the binary format 104 of the DSL program can be generated and/or updated (e.g., converting the comparison to instructions).

Illustrative example use cases are detailed in connection with FIG. 2 through FIG. 4, wherein such example uses cases include the utilization of a compiler for a machine learning model. Also, in the example use cases, data of the machine learning model are represented with tensor, and then lowered to MemRef. In such an example use case, tensor refers to an algebraic object that describes a multilinear relationship between sets of algebraic objects related to a vector space, and MemRef refers to an implementation for tensor and is related to certain storage. More particularly, the tensor representation is an immutable value-based array including, e.g., tensor<4x5xf32> or tensor <?x10xf32>, while the MemRef representation is a mutable buffer including, e.g., memref<4x5xf32> or tensor<?x10xf32>.

Also, in the example use cases detailed below, these data representation types have static and/or dynamic size information attached. For example, if the mark “?” is used for a dynamic dimension, its dynamic value can be retrieved with a dimOf operation (e.g., dimof(% a, 0)). As used herein, a dimOf operation returns an expression for the size of a certain dimension of a MemRef.

FIG. 2 shows example pseudocode for an in-bound example in connection with a static analysis in an illustrative embodiment. In this embodiment, example pseudocode 200 is executed by or under the control of at least one processing system and/or device.

The example pseudocode 200 illustrates a static analysis wherein memory access is within designated boundaries (also referred to herein as bound). When loops and accesses are affine, one or more embodiments include using polyhedral analysis to determine whether a memory access is within its bound. If the domain of the loop nest is D, the access function of loop iteration vector I is A(I), and if the upper and lower bounds of the memory object are LB and LU, respectively, such an embodiment includes proving the following via Equation (1):

$$LB \leq A ( I ) < LU \qquad ( 1 )$$

for all I in D, and wherein a result or “maybe” is treated as “no.” As used herein, a loop nest refers to a loop inside of a body of another loop, wherein their iterations will be correlated. It is to be appreciated that this particular example pseudocode shows just one example implementation of an in-bound static analysis output, and alternative implementations which include other or alternative content and follows other or alternative rules can be used in other embodiments.

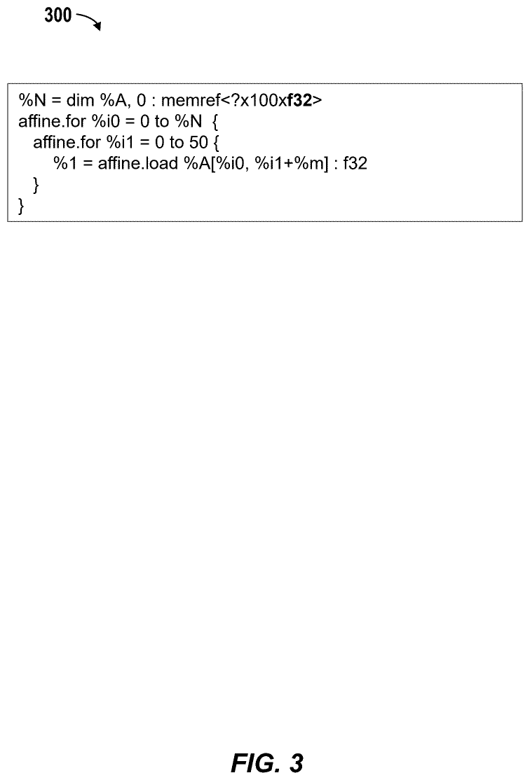

FIG. 3 shows example pseudocode for a potentially not in-bound example in connection with a static analysis in an illustrative embodiment. In this embodiment, example pseudocode 300 is executed by or under the control of at least one processing system and/or device.

The example pseudocode 300 illustrates a static analysis wherein data-flow analysis is used on one or more pointers to detect potential accesses through one or more dangling pointer accesses. As used herein, a pointer refers to a variable that holds a value of address. For example, consider accessing a location with an object and indices: A[1, 2]. If an address is stored in a pointer variable, p, a location may be accessed by dereferencing the pointer. As used herein, a pointer is not dangling if the pointer is not transitively upward-exposed to a free operation. At least one embodiment includes constructing at least one concurrent data flow graph for a multi-threaded program.

It is to be appreciated that this particular example pseudocode shows just one example implementation of a potentially not in-bound static analysis output, and alternative implementations which include other or alternative content and follows other or alternative rules can be used in other embodiments.

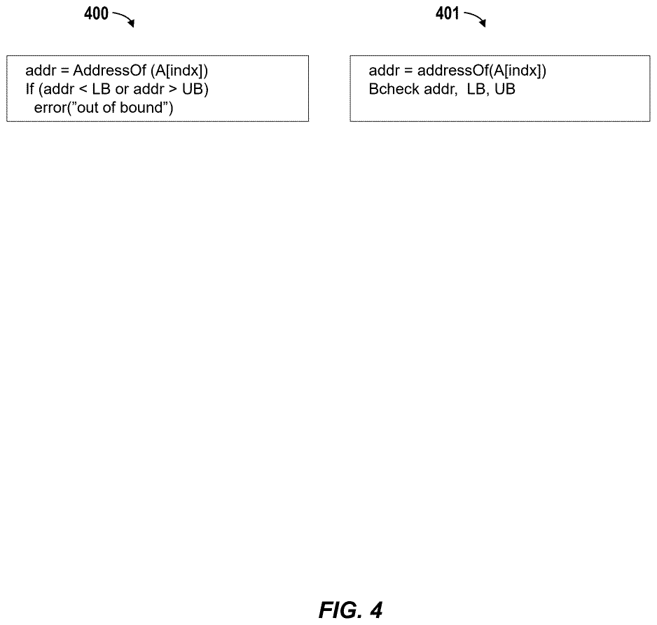

FIG. 4 shows example pseudocode for implementing at least a portion of a runtime analysis in an illustrative embodiment. In this embodiment, example pseudocode 400 and example pseudocode 401 are executed by or under the control of at least one processing system and/or device.

Example pseudocode 400 illustrates generating a dynamic/runtime check if a static analysis (such as carried out in connection with FIG. 3) cannot prove access security (e.g., the static analysis output determines a (potentially) not in-bound result). At least one embodiment includes generating such a bound check at runtime and/or generating a use-after-free check (e.g., a type of memory-related issue, wherein a memory object can be accessed after the object has already been freed). More particularly, such a runtime check can be implemented in software including, e.g., analyzing overhead from extra operations for checking, code size expansion, etc. Additionally, one or more embodiments can include adding hardware support to reduce the overhead. More particularly, example pseudocode 401 illustrates implementing special instructions for a bound check (Bcheck), wherein such instructions can be related to Bcheck address, Bcheck size, the lower bound (LB), and/or the upper bound (UB). In such an embodiment, special hardware can be utilized to perform the comparison(s), and an interruption can be raised and/or implemented if the check fails.

It is to be appreciated that this particular example pseudocode shows just one example implementation of at least a portion of a dynamic runtime analysis, and alternative implementations which include other or alternative content and follows other or alternative rules can be used in other embodiments.

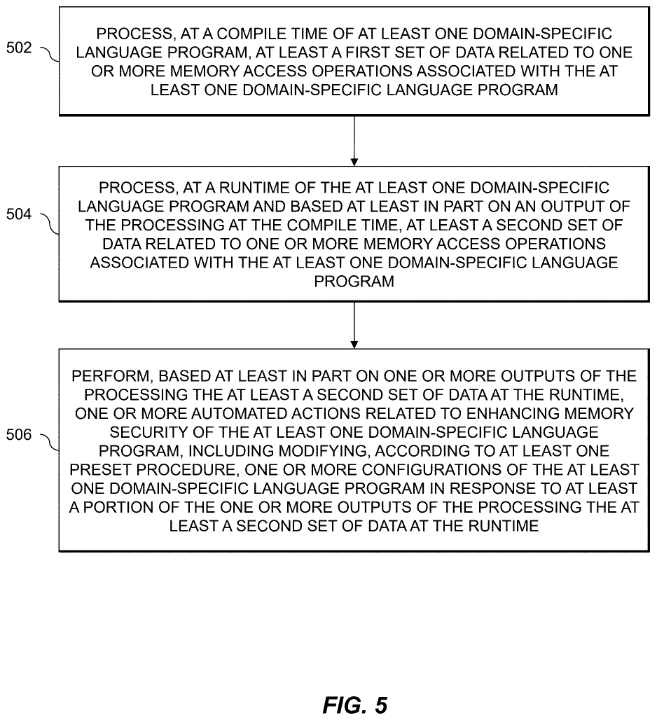

FIG. 5 is a flow diagram illustrating techniques according to an embodiment of the present invention. Step 502 includes processing, at a compile time of at least one domain-specific language program (e.g., at least one artificial intelligence-based domain-specific language program), at least a first set of data related to one or more memory access operations associated with the at least one domain-specific language program. In at least one embodiment, processing the at least a first set of data at a compile time of the at least one domain-specific language program includes processing the at least a first set of data related to one or more memory access operations associated with the at least one domain-specific language program using one or more loop analysis techniques to determine whether each of the one or more memory access operations is within one or more designated boundaries. In such an embodiment, the one or more loop analysis techniques include one or more polyhedral analysis techniques.

Additionally or alternatively, processing the at least a first set of data at a compile time of the at least one domain-specific language program can include processing the at least a first set of data related to one or more memory access operations associated with the at least one domain-specific language program using one or more data-flow analysis techniques to determine whether each of the one or more memory access operations is within one or more designated boundaries. In such an embodiment, using one or more data-flow analysis techniques can include using one or more data-flow analysis techniques on one or more pointers associated with the at least one domain-specific language program to determine whether at least one of the one or more memory access operations is carried out through at least one dangling pointer access.

Step 504 includes processing, at a runtime of the at least one domain-specific language program and based at least in part on an output of the processing at the compile time, at least a second set of data related to one or more memory access operations associated with the at least one domain-specific language program. In one or more embodiments, processing the at least a second set of data at a runtime of the at least one domain-specific language program includes processing the at least a second set of data related to one or more memory access operations associated with the at least one domain-specific language program upon a determination that the output of the processing at the compile time indicates that at least one of the one or more memory access operations is anomalous. Additionally or alternatively, processing the at least a second set of data at a runtime of the at least one domain-specific language program can include processing the at least a second set of data at the runtime of the at least one domain-specific language program in conjunction with hardware support related to the at least one domain-specific language program.

Step 506 includes performing, based at least in part on one or more outputs of the processing the at least a second set of data at the runtime, one or more automated actions related to enhancing memory security of the at least one domain-specific language program, wherein performing the one or more automated actions includes modifying, according to at least one preset procedure, one or more configurations of the at least one domain-specific language program in response to at least a portion of the one or more outputs of the processing the at least a second set of data at the runtime. In at least one embodiment, performing one or more automated actions includes modifying, according to at least one preset procedure, one or more configurations of the at least one domain-specific language program in response to at least a portion of the one or more outputs of the processing the at least a second set of data at the runtime. By way of example, an error might be reported and/or an exception might be raised based at least in part on the runtime check result, and one or more related automated actions can be initiated in response thereto. In one or more embodiments, such related automated actions can include, for example, enhancing security of the at least one domain-specific language program by automatically implementing one or more patches to modify at least one corresponding portion of the at least one domain-specific language program, automatically updating one or more relevant program instructions of the at least one domain-specific language program, etc.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as improved DSL-related memory security code 626. In addition to improved DSL-related memory security code 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and improved DSL-related memory security code 626, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

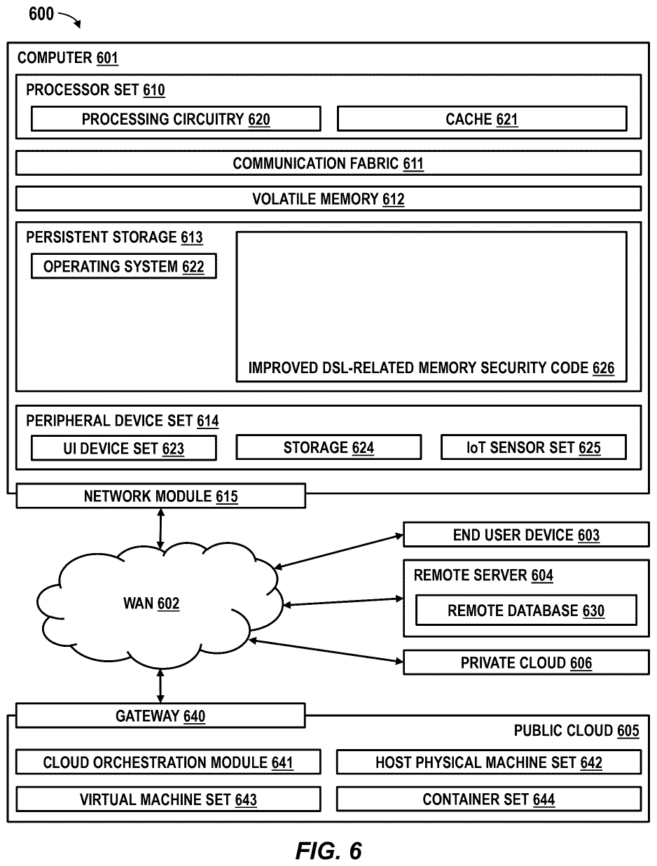

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in improved DSL-related memory security code 626 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type RAM or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a ROM, but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in improved DSL-related memory security code 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

In computing environment 600, computer 601 is shown as being connected to the internet (see WAN 602). However, in many embodiments of the present invention computer 601 will be isolated from communicating over communications network and not connected to the internet, running as a standalone computer. In these embodiments, network module 615 of computer 601 may not be necessary or even desirable in order to ensure isolation and to prevent external communications coming into computer 601. The standalone computer embodiments are potentially advantageous, at least in some applications of the present invention, because they are typically more secure. In other embodiments, computer 601 is connected to a secure WAN or a secure LAN instead of WAN 602 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
processing, at a compile time of at least one domain-specific language program, at least a first set of data related to one or more memory access operations associated with the at least one domain-specific language program;
processing, at a runtime of the at least one domain-specific language program and based at least in part on an output of the processing at the compile time, at least a second set of data related to one or more memory access operations associated with the at least one domain-specific language program; and
performing, based at least in part on one or more outputs of the processing the at least a second set of data at the runtime, one or more automated actions related to enhancing memory security of the at least one domain-specific language program, wherein performing the one or more automated actions comprises modifying, according to at least one preset procedure, one or more configurations of the at least one domain-specific language program in response to at least a portion of the one or more outputs of the processing the at least a second set of data at the runtime;
wherein the method is carried out by at least one computing device.

2. The computer-implemented method of claim 1, wherein processing the at least a first set of data at a compile time of the at least one domain-specific language program comprises processing the at least a first set of data related to one or more memory access operations associated with the at least one domain-specific language program using one or more loop analysis techniques to determine whether each of the one or more memory access operations is within one or more designated boundaries.

3. The computer-implemented method of claim 2, wherein the one or more loop analysis techniques comprises one or more polyhedral analysis techniques.

4. The computer-implemented method of claim 1, wherein processing the at least a first set of data at a compile time of the at least one domain-specific language program comprises processing the at least a first set of data related to one or more memory access operations associated with the at least one domain-specific language program using one or more data-flow analysis techniques to determine whether each of the one or more memory access operations is within one or more designated boundaries.

5. The computer-implemented method of claim 4, wherein using one or more data-flow analysis techniques comprises using one or more data-flow analysis techniques on one or more pointers associated with the at least one domain-specific language program to determine whether at least one of the one or more memory access operations is carried out through at least one dangling pointer access.

6. The computer-implemented method of claim 1, wherein processing the at least a second set of data at a runtime of the at least one domain-specific language program comprises processing the at least a second set of data related to one or more memory access operations associated with the at least one domain-specific language program upon a determination that the output of the processing at the compile time indicates that at least one of the one or more memory access operations is anomalous.

7. The computer-implemented method of claim 1, wherein processing the at least a second set of data at a runtime of the at least one domain-specific language program comprises processing the at least a second set of data at the runtime of the at least one domain-specific language program in conjunction with hardware support related to the at least one domain-specific language program.

8. The computer-implemented method of claim 1, wherein automatically modifying one or more configurations of the at least one domain-specific language program comprises:
automatically identifying at least one of one or more errors and one or more exceptions associated with the at least one domain-specific language program in response to at least a portion of the one or more outputs of the processing the at least a second set of data at the runtime; and
enhancing security of the at least one domain-specific language program by automatically implementing, in response to the identifying of at least one of one or more errors and one or more exceptions, at least one of one or more patches to modify at least one corresponding portion of the at least one domain-specific language program, and one or more updates to one or more relevant program instructions of the at least one domain-specific language program.

9. The computer-implemented method of claim 1, wherein the at least one domain-specific language program comprises at least one artificial intelligence-based domain-specific language program.

10. A computer system comprising:
a processor set;
one or more computer-readable storage media; and
program instructions stored on the one or more computer-readable storage media to cause the processor set to perform operations comprising:
processing, at a compile time of at least one domain-specific language program, at least a first set of data related to one or more memory access operations associated with the at least one domain-specific language program;
processing, at a runtime of the at least one domain-specific language program and based at least in part on an output of the processing at the compile time, at least a second set of data related to one or more memory access operations associated with the at least one domain-specific language program; and
performing, based at least in part on one or more outputs of the processing the at least a second set of data at the runtime, one or more automated actions related to enhancing memory security of the at least one domain-specific language program, wherein performing the one or more automated actions comprises modifying, according to at least one preset procedure, one or more configurations of the at least one domain-specific language program in response to at least a portion of the one or more outputs of the processing the at least a second set of data at the runtime.

11. The computer system of claim 10, wherein processing the at least a first set of data at a compile time of the at least one domain-specific language program comprises processing the at least a first set of data related to one or more memory access operations associated with the at least one domain-specific language program using one or more loop analysis techniques to determine whether each of the one or more memory access operations is within one or more designated boundaries.

12. The computer system of claim 10, wherein processing the at least a first set of data at a compile time of the at least one domain-specific language program comprises processing the at least a first set of data related to one or more memory access operations associated with the at least one domain-specific language program using one or more data-flow analysis techniques to determine whether each of the one or more memory access operations is within one or more designated boundaries.

13. The computer system of claim 10, wherein processing the at least a second set of data at a runtime of the at least one domain-specific language program comprises processing the at least a second set of data related to one or more memory access operations associated with the at least one domain-specific language program upon a determination that the output of the processing at the compile time indicates that at least one of the one or more memory access operations is anomalous.

14. The computer system of claim 10, wherein processing the at least a second set of data at a runtime of the at least one domain-specific language program comprises processing the at least a second set of data at the runtime of the at least one domain-specific language program in conjunction with hardware support related to the at least one domain-specific language program.

15. The computer system of claim 10, wherein automatically modifying one or more configurations of the at least one domain-specific language program comprises:
automatically identifying at least one of one or more errors and one or more exceptions associated with the at least one domain-specific language program in response to at least a portion of the one or more outputs of the processing the at least a second set of data at the runtime; and
enhancing security of the at least one domain-specific language program by automatically implementing, in response to the identifying of at least one of one or more errors and one or more exceptions, at least one of one or more patches to modify at least one corresponding portion of the at least one domain-specific language program, and one or more updates to one or more relevant program instructions of the at least one domain-specific language program.

16. A computer program product comprising:
one or more computer-readable storage media; and
program instructions stored on the one or more computer-readable storage media to perform operations comprising:
processing, at a compile time of at least one domain-specific language program, at least a first set of data related to one or more memory access operations associated with the at least one domain-specific language program;
processing, at a runtime of the at least one domain-specific language program and based at least in part on an output of the processing at the compile time, at least a second set of data related to one or more memory access operations associated with the at least one domain-specific language program; and
performing, based at least in part on one or more outputs of the processing the at least a second set of data at the runtime, one or more automated actions related to enhancing memory security of the at least one domain-specific language program, wherein performing the one or more automated actions comprises modifying, according to at least one preset procedure, one or more configurations of the at least one domain-specific language program in response to at least a portion of the one or more outputs of the processing the at least a second set of data at the runtime.

17. The computer program product of claim 16, wherein processing the at least a first set of data at a compile time of the at least one domain-specific language program comprises processing the at least a first set of data related to one or more memory access operations associated with the at least one domain-specific language program using one or more loop analysis techniques to determine whether each of the one or more memory access operations is within one or more designated boundaries.

18. The computer program product of claim 16, wherein processing the at least a first set of data at a compile time of the at least one domain-specific language program comprises processing the at least a first set of data related to one or more memory access operations associated with the at least one domain-specific language program using one or more data-flow analysis techniques to determine whether each of the one or more memory access operations is within one or more designated boundaries.

19. The computer program product of claim 16, wherein processing the at least a second set of data at a runtime of the at least one domain-specific language program comprises processing the at least a second set of data related to one or more memory access operations associated with the at least one domain-specific language program upon a determination that the output of the processing at the compile time indicates that at least one of the one or more memory access operations is anomalous.

20. The computer program product of claim 16, wherein automatically modifying one or more configurations of the at least one domain-specific language program comprises:
automatically identifying at least one of one or more errors and one or more exceptions associated with the at least one domain-specific language program in response to at least a portion of the one or more outputs of the processing the at least a second set of data at the runtime; and
enhancing security of the at least one domain-specific language program by automatically implementing, in response to the identifying of at least one of one or more errors and one or more exceptions, at least one of one or more patches to modify at least one corresponding portion of the at least one domain-specific language program, and one or more updates to one or more relevant program instructions of the at least one domain-specific language program.
